(19) United States
(12) Patent Application Publication
(10) Pub. No.: US 2024/0149702 A1
(43) Pub. Date: May 9, 2024

(54) OVERSPEED DETECTION DEVICE

(71) Applicant: Aldebaran, Paris (FR)

(72) Inventors: Alexis MONACI, PARIS (FR); Guillaume QUERIN, PARIS (FR)

(21) Appl. No.: 18/385,301

(22) Filed: Oct. 30, 2023

(30) Foreign Application Priority Data
Nov. 4, 2022 (FR) 2211515

(51) Int. Cl. B60L 15/20; G01P 3/481; G01P 21/00; G01S 17/89; G01S 17/931

(52) U.S. Cl. CPC B60L 15/2009; G01P 3/481; G01P 21/00; G01S 17/89; G01S 17/931; B60L 2240/461

(57) ABSTRACT

A vehicle includes a chassis and a motor/wheel assembly comprising a drive wheel and a drive electric motor, the vehicle comprising an overspeed detection device, the overspeed detection device comprising a first sensor, the first sensor being configured to measure a speed of rotation, the overspeed detection device comprising a speed reference device for establishing a maximum speed of rotation, the reference device comprising an optical sensor for determining a close environment, the maximum speed of rotation being a function of the close environment, of a predefined functional speed threshold and of a direction of rotation, the overspeed detection device comprising a comparator for comparing the speed of rotation with the maximum speed of rotation, the comparator being configured to stop the rotation of the drive wheel if the speed of rotation is greater than the maximum speed of rotation.

### CROSS-REFERENCE TO RELATED APPLICATION

This application claims priority to foreign French patent application No. FR 2211515, filed on Nov. 4, 2022, the disclosure of which is incorporated by reference in its entirety.

### FIELD OF THE INVENTION

The invention relates to the field of autonomously moving robots and, more specifically, to autonomous mobile robots which are able to transport goods or loads over a predefined area of movement.

### BACKGROUND

Autonomous mobile robots which make it possible to move objects are specifically designed for autonomous and safe driving.

The safety system of such autonomous mobile robots comprises means for detecting obstacles in a predefined area of movement around the autonomous mobile robot and means for bringing the autonomous mobile robot to a stop safely before colliding with any obstacle detected in a defined area of movement.

A known solution for detecting obstacles all around the autonomous mobile robot is to mount two laser scanners opposite one another at the corners of a typically rectangular mobile robot. Each scanner generally covers a field of view of 270°, that is to say from one side of the mobile robot to another side for a corresponding corner. Thus, the two scanners may cover a protective area around the autonomous mobile robot.

In a known manner, such a type of autonomous mobile robot may also comprise other types of sensors making it possible, for example, to measure the speed of the autonomous mobile robot at any instant.

It is then possible to detect, on the basis of the data from the scanners and/or from the sensors, a potential overspeed situation for the autonomous mobile robot which is reflected in a situation during which the autonomous mobile robot moves at a speed which may be described as excessive, notably with respect to its area of movement and with respect to its close environment. This is notably the case when the autonomous mobile robot moves close to obstacles; it must then adapt its speed and its movement with respect to its close environment and to these obstacles.

All these sensors and scanners are generally connected to a digital controller which analyses the digital obstacle presence and speed data supplied by the various sensors and/or scanners in order to control the drive wheels of the autonomous mobile robot. The digital controller thus adapts the speed and the trajectories of the autonomous mobile robot in real time with respect to the close environment of the robot and with respect to the immediate danger which the obstacles identified by the sensors or by the scanners may represent.

However, using such a digital controller and such digital sensors has numerous drawbacks. Specifically, using a digital controller or a digital encoder generates complexity in the architecture of the autonomous mobile robot because, notably, of using digital means. Besides the high costs of such an architecture, its complexity may lead to long reaction times which are incompatible with the safety of the robot. In addition, in terms of safety related to using such digital means to obtain control of the movement and of the braking of the autonomous mobile robot, a digital controller also has the drawback of having to comply with safety standards. Certification to these standards may be difficult to obtain.

In order to avoid using a software architecture mentioned above, relying exclusively on a hardware architecture employing wired analogue and logic components in order to manage the speed of the mobile robot in its area of movement may be envisaged. Specifically, employing a hardware architecture has the advantage of meeting different, less restrictive safety standards, in comparison with a software architecture.

### SUMMARY OF THE INVENTION

Thus, the invention aims to mitigate all or some of the problems mentioned above by proposing a device for detecting an overspeed of the autonomous mobile robot operating exclusively according to a hardware logic and requiring only the use of a simple sensor positioned in a drive wheel of the autonomous mobile robot or on a shaft driven by the wheel and on a lidar sensor making it possible to detect obstacles and the close environment of the autonomous mobile robot. This overspeed detection device operating only according to a hardware architecture thus has the advantage of being simpler than a software architecture, while at the same time perfectly meeting the safety standards applying to this type of system.

The invention also has the advantage of employing a logic device which is independent of the motor control, which ensures that the vehicle is safer.

To this end, the subject of the invention is a vehicle configured to move in an area of movement, the vehicle comprising a chassis and a motor/wheel assembly comprising at least one drive wheel and an electric motor driving the drive wheel in rotation, the vehicle comprising an overspeed detection device for the drive wheel, the overspeed detection device comprising a first overspeed sensor, the first overspeed sensor being configured to measure a speed of rotation of the drive wheel,
the overspeed detection device comprising a speed reference device configured to establish a maximum speed of rotation of the drive wheel, the speed reference device comprising an optical sensor configured to determine a close environment of the drive wheel, the optical sensor being arranged against the chassis, the maximum speed of rotation being at least a function of the close environment, of a predefined functional speed threshold and of a direction of rotation of the drive wheel,
the overspeed detection device comprising a speed comparator for comparing the speed of rotation of the drive wheel with the maximum speed of rotation of the drive wheel, the speed comparator being configured to stop the rotation of the drive wheel if the speed of rotation of the drive wheel is greater than the maximum speed of rotation of the drive wheel,
the first overspeed sensor comprising a signal converter configured to convert a switching frequency of the first overspeed sensor into an analogue voltage.

According to one aspect of the invention, the first overspeed sensor comprises a fixed element positioned in the drive wheel and at least one mobile element positioned at a radial extremity of the mobile wheel with respect to the axis of rotation.

According to one aspect of the invention, the first overspeed sensor comprises a filter arranged between the signal converter and the speed comparator.

According to one aspect of the invention, the optical sensor is a lidar sensor.

According to one aspect of the invention, the lidar sensor is configured to generate a first map of the close environment, and the lidar sensor comprises a second programming input configured to program an area of attention of the vehicle in the area of movement.

According to one aspect of the invention, the overspeed detection device comprises a second overspeed sensor arranged at a predefined angle with respect to the first overspeed sensor, the second overspeed sensor being configured to measure a speed of rotation of the drive wheel.

According to one aspect of the invention, the first overspeed sensor and the second overspeed sensor are Hall effect sensors or rotary sensors or optical sensors.

According to one aspect of the invention, the overspeed detection device comprises a third overspeed sensor arranged at a predefined angle with respect to the first overspeed sensor and with respect to the second overspeed sensor, the third overspeed sensor being configured to measure a speed of rotation of the drive wheel.

According to one aspect of the invention, the overspeed detection device comprises a generalized malfunction detector for the first overspeed sensor, for the second overspeed sensor and for the third overspeed sensor, the generalized malfunction detector being configured to detect a simultaneous malfunction of the first overspeed sensor and of the second overspeed sensor, or of the second overspeed sensor and of the third overspeed sensor, or of the first overspeed sensor and of the third overspeed sensor, or indeed of the first overspeed sensor, of the second overspeed sensor and of the third overspeed sensor.

According to one aspect of the invention, the electric motor is incorporated into the drive wheel.

### BRIEF DESCRIPTION OF THE DRAWINGS

The invention will be better understood and other advantages will become apparent on reading the detailed description of an embodiment given by way of example, which description is illustrated by the appended drawing, in which:

FIG. 1 shows a schematic view of an autonomous vehicle comprising an overspeed detection device for the vehicle according to the invention;

FIG. 2 shows a schematic view of the autonomous vehicle according to a second configuration mode;

FIG. 3 shows a schematic view of the autonomous vehicle of FIG. 1 comprising two overspeed sensors;

FIG. 4 shows a schematic view of the autonomous vehicle comprising a generalized malfunction detector according to the invention;

FIG. 5 shows a schematic view of the autonomous vehicle comprising a preferable configuration of the overspeed detection device according to the invention.

For the sake of clarity, the same elements bear the same reference signs in the various figures.

### DETAILED DESCRIPTION

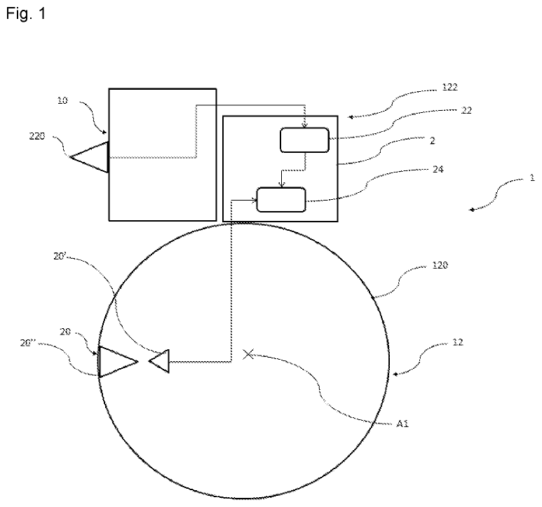

FIG. 1 shows a schematic view of a vehicle 1 configured to move in an area of movement. The vehicle 1 may be interpreted as any land vehicle which is able to move by means of wheels. According to one preferable aspect of the invention, the vehicle 1 may be a robot which is able to move autonomously.

The vehicle 1 comprises a chassis 10 and a motor/wheel assembly 12. The chassis 10 is connected to the motor/wheel assembly 12, which comprises a drive wheel 120 and an electric motor 122. The electric motor 122 is controlled by a controller (which is not shown) delivering, to the motor, an electrical signal adapted for a given speed setpoint. In this exemplary embodiment, the motor/wheel assembly 12 is an assembly which comprises the electric motor 122 incorporated directly into the drive wheel 120, which is capable of propelling the vehicle 1. The main advantages of such a motor/wheel assembly 12 are its reduced bulk and the fact that it does not require transmission between the electric motor 122 and the drive wheel 120. The drive wheel 120 is then driven in rotation directly by the electric motor 120 about an axis of rotation A1.

In a variant, the electric motor 122 is on a shaft driven by the drive wheel 120. Dissociating the electric motor 122 from the drive wheel 120 has the advantage of making it possible for the electric motor 122 to drive several drive wheels by means of the drive shaft.

The vehicle 1 also comprises an overspeed detection device 2 for the drive wheel 120. The overspeed detection device 2 is configured to detect when the vehicle 1 is in an overspeed situation in its area of movement. For this purpose, the overspeed detection device 2 comprises a first overspeed sensor 20 placed on the drive wheel 120. More specifically, the first overspeed sensor 20 comprises a fixed element 20′ positioned in the drive wheel 120, or close to its axis of rotation A1, and one or more mobile elements 20″ positioned at a radial extremity of the mobile wheel 120 with respect to the axis of rotation A1. The fixed element 20′ is arranged so as to be immobile in the drive wheel 120 and makes it possible to have a reference measurement for the rotation of the drive wheel 120. In a variant, the mobile element 20″ is fixed randomly against the drive wheel 120.

More specifically, when the mobile element 20″ undergoes a complete rotation with respect to the fixed element 20′, reflecting a complete rotation of the drive wheel 120 on itself, the overspeed sensor 20 then detects this complete rotation by switching from an incomplete state to a complete state. The incomplete state of the overspeed sensor 20 therefore reflects a non-complete rotation of the drive wheel 120 and of the mobile element 20″, whereas the complete state reflects a complete rotation, that is to say of 360°, of the drive wheel 120 and of the mobile element 20″. Following a switch to the complete state, the first overspeed sensor 20 switches again to the incomplete state until it detects a new complete rotation of the drive wheel 120. The first overspeed sensor 20 is then configured to measure a speed of rotation of the drive wheel 120. The fixed element 20′ of the first overspeed sensor 20 is positioned with respect to a defined reference frame, for example close to the extremity of the drive wheel 120 at a known angle. Consequently, it is possible for the overspeed sensor 20 to measure an angle of rotation of the drive wheel 120 during the rotation of the drive wheel 120 or indeed an angle of rotation of the mobile element 20″ with respect to the fixed element 20′ of the overspeed sensor 20. In a variant, the reference frame may be any point, such as the point of contact between the drive wheel 120 and the interface on which the drive wheel 120 moves.

The fixed element 20′ and the mobile element or elements 20″ are preferably arranged so as to be at a short distance from one another in order to improve detection by the first overspeed sensor. Also, according to an ideal variant, the mobile element or elements 20″ are arranged as close as possible to the fixed element 20′ without the fixed element 20′ being in contact with the or one of the mobile elements 20″. By way of indicative example, the fixed element 20′ is at a distance of less than 15 millimetres from the mobile element or elements.

Consequently, it is also possible to know precisely the number of complete rotations which the drive wheel 120 has performed and, knowing the time for which the drive wheel 120 is in motion, it is also possible for the overspeed sensor 20 to measure the speed of rotation of the drive wheel 120 in real time. The overspeed sensor 20 therefore acts as a sensor for sensing the angular position of the mobile element 20″ with respect to the fixed element 20′ and with respect to the defined reference frame and as a sensor for sensing the speed of rotation by measuring the switching frequency from the incomplete state to the complete state of the overspeed sensor 20.

The overspeed detection device 2 also comprises a speed reference device 22 configured to establish a maximum speed of rotation of the drive wheel 120. The speed reference device 22 performs the function of making the rotation of the drive wheel 120 safe and makes it possible to define the physical and functional limits of the drive wheel 120 when the drive wheel 120 is in motion. For this purpose, the speed reference device 22 comprises a lidar sensor 220 configured to determine a close environment of the drive wheel 120. The lidar sensor 220 is attached to the chassis 10 so as to be able to continuously emit a light wave in a predefined direction. Advantageously, the lidar sensor 220 emits a light wave in a direction of movement of the vehicle 1 so as to make it possible for the lidar sensor 220 to detect, sufficiently rapidly, any obstacle which appears in front of the vehicle 1 and which may cause an accident.

Advantageously, the speed reference device 22 may comprise several lidar sensors 220 orientated in various directions so as to be able to perform a more complete mapping of the close environment of the vehicle 1.

Specifically, the close environment of the vehicle 1 is defined as the area close to the vehicle 1 subjected to the light waves from the lidar sensor 220. The close environment is therefore an area which is close and accessible to the vehicle 1, contained in the area of movement of the vehicle and mapped by the lidar sensor 220.

The close environment may also be interpreted as the critical area of the vehicle 1, in which it is possible that the vehicle 1 encounters an obstacle during its movement and which may be identified by the lidar sensor 220. The notion of closeness may also be interpreted as a distance between an object identified by the lidar sensor 220 and the vehicle 1 which is short enough to risk a collision. The close environment depends notably on the speed of rotation of the drive wheel 120.

Consequently, in order to prevent any unwanted collision between the vehicle 1 and a potential obstacle, the speed reference device 22 makes it possible to establish a maximum speed of rotation of the drive wheel 120 in order to limit the speed of movement of the vehicle when the close environment of the vehicle 1 identified by the lidar sensor 220 presents obstacles which are liable to lead to collisions.

The maximum speed of rotation of the drive wheel 120 is then a speed calculated by the speed reference device 22 as a function of the close environment, of a predefined functional speed threshold and of a direction of rotation of the wheel. More specifically, the functional speed threshold defines the maximum speed at which the vehicle 1 may move functionally and fulfil the function for which the vehicle 1 has been defined.

By way of indicative example, when the lidar sensor 220 detects, in the close environment, a potential obstacle risking a collision with the vehicle, then the speed reference device 22 establishes a low maximum speed of rotation of the drive wheel 120. The reference device may also establish a lower maximum speed of rotation of the drive wheel 120 when the vehicle 1 is loaded and when the functional speed threshold is lower.

The maximum speed of rotation is an indicative speed. Specifically, the maximum speed of rotation must be interpreted as the speed at which the drive wheel 120 must move in order to comply with the information related to its close environment and to its operation. The maximum speed of rotation of the drive wheel is therefore a speed reference which fluctuates in real time as a function of the parameters mentioned above.

The overspeed detection device 2 also comprises a speed comparator 24 configured to compare the speed of rotation of the drive wheel 120 and the maximum speed of rotation of the drive wheel 120 established by the speed reference device 22. The speed comparator 24 is also configured to stop the rotation of the drive wheel 120 if the speed of rotation of the drive wheel 120 is greater than the maximum speed of rotation of the drive wheel 120 established by the speed reference device 22.

Thus, when the speed of rotation of the drive wheel 120 is greater than the maximum speed of rotation established by the speed reference device 22, then the vehicle 1 moves too quickly with respect to its close environment and there is a significant risk of a collision between an obstacle identified or not by the lidar sensor 220 and the vehicle 1. The speed comparator 24 then acts directly on the electric motor 122 to brake the electric motor 122 and the drive wheel 120. Advantageously, the speed comparator 24 may also act on the electric motor 122 to stop the drive wheel 120. The speed comparator 24 thus makes it possible to act as a safeguard against a potential overspeed situation for the drive wheel 120 and for the vehicle 1 by stopping the rotation of the drive wheel 120.

Such an embodiment advantageously makes it possible for the speed comparator 24 to perform a safety function in the event of overspeed, for example due to a failure of the controller.

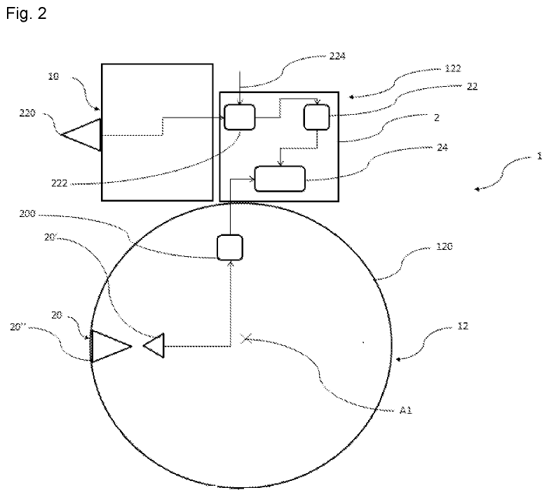

In order to measure the rotation of the drive wheel 120 and the speed of rotation of the drive wheel 120 more easily, the first overspeed sensor 20 may comprise a signal converter 200, as shown in FIG. 2, configured to convert a switching frequency of the first overspeed sensor 20 into a binary signal or an analogue signal. By way of preferable example, the signal converter 200 is configured to convert the switching frequency of the first overspeed sensor 20 into an analogue voltage. As said above, when the mobile element 20″ undergoes a complete rotation with respect to the fixed element 20′, reflecting a complete rotation of the drive wheel 120 on itself, the overspeed sensor 20 then detects this complete rotation by switching from the incomplete state to the complete state. Following the switch to the complete state, the first overspeed sensor 20 switches again to the incomplete state until it detects a new complete rotation of the drive wheel 120. In order to make it easier to detect this switch reflecting a complete rotation of the drive wheel 120, converting this switch according to an analogue signal may thus be envisaged. Converting according to the analogue signal thus makes it possible to highlight a frequency of appearance of the switch of the overspeed sensor 20 and therefore a measurement of the speed of rotation of the drive wheel 120. By way of indicative example, the signal converter 200 may generate an electrical signal between 0 volts and 5 volts in order to measure the speed of rotation of the drive wheel 120.

Using the overspeed detection device 2, and more particularly the first overspeed sensor 20, the speed comparator 24 and the signal converter 200 thus has the advantage of dissociating the management of the speed of the vehicle and of the drive wheel 120 from the general management of the autonomous vehicle by the controller. The overspeed detection device 2 thus comprises a set of simple components or logic gates such as the signal converter 200 operating in a dissociated fashion with respect to the controller, which comprises digital and complex components. The overspeed detection device 2 is therefore a simple and reliable system for making it possible to manage the speed of the autonomous vehicle with respect to the fallible digital controller. The detection of an overspeed is therefore independent of the operation of the autonomous vehicle, and particularly of the digital controller.

In a variant, the overspeed sensor 20 may also be configured to measure an angle of rotation between the mobile element 20″ and the fixed element 20′. Specifically, when the speed of rotation of the drive wheel 120 is low, the switching frequency of the overspeed sensor 20 is also low and it then becomes difficult to measure this speed of rotation. Knowing this angle of rotation then makes it possible to measure the speed of rotation of the drive wheel 120 without detecting a complete rotation of the drive wheel 120. The signal converter 200 may also make it possible to measure this angle of rotation via a square-wave signal, for example, or via any other periodic signal or indeed periodic signal having a frequency which is proportional to the speed of rotation of the electric motor 120.

In other words, the first overspeed sensor 20 makes it possible to measure a complete rotation or an angle of rotation of the drive wheel 120 and the speed of rotation of the drive wheel 120 via the switching frequency of the first overspeed sensor 20 between the incomplete and complete states.

The lidar sensor 220 is thus configured to identify or digitally represent the close environment of the vehicle 1 by means of a first map 222. The lidar sensor 220 makes it possible, by means of this first map 222, to scan the close environment and to know where objects are in its field of vision and at what distance with respect to the vehicle 1.

Programming, in the lidar sensor 220 by means of a second programming input 224, an area of attention of the vehicle 1 in the first map 222, may also be envisaged. Programming this area of attention makes it possible for a user to define, in the area of movement of the vehicle 1, areas in which the vehicle 1 must not move or must move at restricted speeds. These areas of attention may thus be interpreted as critical areas where a collision is very much envisaged.

It is thus possible to obtain a first more precise map combining the scan of the lidar sensor 220 and the programming of the areas of attention by means of the second programming input 224 of the lidar sensor 220. The area or areas of attention may also be programmed upstream of a movement of the vehicle 1 or during the movement of the vehicle 1 in its area of movement.

Replacing the lidar sensor 220 with another optical or closeness sensor such as a sonar, a ToF sensor or indeed a camera may also be envisaged.

Thus, on the basis of the first map 222, which is or is not supplemented by the second programming input 224, the speed reference device 22 establishes the maximum speed of rotation of the drive wheel 120. As stated above, the speed reference device may also take other input parameters, such as the physical limits of the vehicle 1, into consideration.

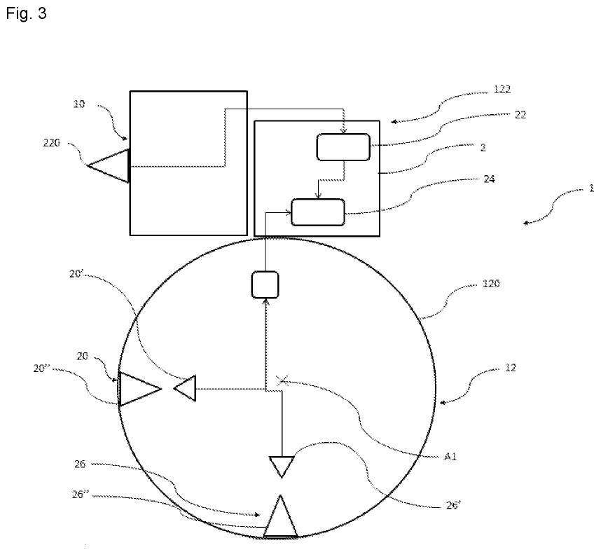

Advantageously, the overspeed detection device 2 may comprise a second overspeed sensor 26, as shown in FIG. 3, attached to the drive wheel 120 and arranged at a predefined angle with respect to the first overspeed sensor 20. Similarly to the first overspeed sensor 20, the second overspeed sensor 26 comprises a fixed element 26′ of the second overspeed sensor positioned close to the axis of rotation A1 of the drive wheel 120 and a mobile element 26″ of the second overspeed sensor 26 positioned at a radial extremity of the mobile wheel 120 with respect to the axis of rotation A1, the mobile element 26″ being arranged at a predefined angle with respect to the mobile element 20″ of the first overspeed sensor 20. The second overspeed sensor 26 is configured to measure a speed of rotation of the wheel. In other words, the second overspeed sensor 26 makes it possible to measure a complete rotation or an angle of rotation of the drive wheel 120 and the speed of rotation of the drive wheel 120 via a switching frequency of the second overspeed sensor 26 between the incomplete and complete states.

Using a second overspeed sensor 26 thus has the advantage of obtaining data related to the rotation of the drive wheel 120 providing redundancy in relation to the data measured by the first overspeed sensor 20. The second overspeed sensor 26 also has the advantage of making it possible to measure a speed of rotation of the wheel without requiring complete rotation of the drive wheel 120.

Specifically, the vehicle 1 generally moves at relatively low speeds, less than three kilometres per hour. Consequently, the time required to obtain a first quantifiable datum of the speed of rotation of the drive wheel 120 may generally require a relatively long time. However, during this time for measuring the speed of rotation, the close environment of the vehicle 1 may easily change and an obstacle in the close environment may appear in front of the vehicle, transforming a nominal operating situation of the vehicle 1 into a potential dangerous collision situation. Using a second overspeed sensor 26 at a predefined angle with respect to the first overspeed sensor 20 thus makes it possible to limit the time required to measure the rotation of the drive wheel 120 and its speed of rotation as this measurement is given when the angle between the first overspeed sensor 20 and the second overspeed sensor 26 is achieved.

In order to make it possible to measure the speed of rotation of the drive wheel 120 as precisely as possible, the overspeed detection device 2 may comprise a third overspeed sensor 28 also attached to the drive wheel 120 and arranged at a predefined angle with respect to the first overspeed sensor 20 and with respect to the second overspeed sensor 26. Similarly to the first overspeed sensor 20 and to the second overspeed sensor 26, the third overspeed sensor 28 comprises a fixed element 28′ of the third overspeed sensor 28 positioned close to the axis of rotation A1 of the drive wheel 120 and a mobile element 28″ of the third overspeed sensor 28 positioned at a radial extremity of the mobile wheel 120 with respect to the axis of rotation A1, the mobile element 28″ of the third overspeed sensor 28 being arranged at a predefined angle with respect to the mobile element 20″ of the first overspeed sensor 20 and with respect to the mobile element 26″ of the second overspeed sensor 26. The third overspeed sensor is also configured to measure a speed of rotation of the drive wheel 120. In other words, the third overspeed sensor 28 makes it possible to measure a complete rotation or an angle of rotation of the drive wheel 120 and the speed of rotation of the drive wheel 120 via a switching frequency of the third overspeed sensor 28 between the incomplete and complete states.

Using three overspeed sensors 20, 26 and 28 thus has the advantage of making a uniform angular distribution in the drive wheel 120 possible without encumbering the motor wheel assembly 12. Furthermore, if one overspeed sensor out of the first overspeed sensor 20, the second overspeed sensor 26 and the third overspeed sensor 28 does not operate correctly, this has no impact on the overspeed detection device 2 in its measurement of the speed of rotation of the drive wheel 120. Multiplying overspeed sensors also makes it possible to meet a redundancy requirement in terms of safety.

According to a preferable variant, the first overspeed sensor 20, the second overspeed sensor 26 and the third overspeed sensor 28 may be envisaged as sharing one and the same fixed element, namely, for example, the fixed element 20′ of the first overspeed sensor 20, and each comprise a predefined number of mobile elements, so that the overspeed detection device 2 comprises a predefined sum of mobile elements distributed uniformly over the drive wheel 120. By way of indicative example, each overspeed sensor may comprise ten mobile elements so that the overspeed detection device 2 comprises thirty mobile elements distributed uniformly over the drive wheel 120.

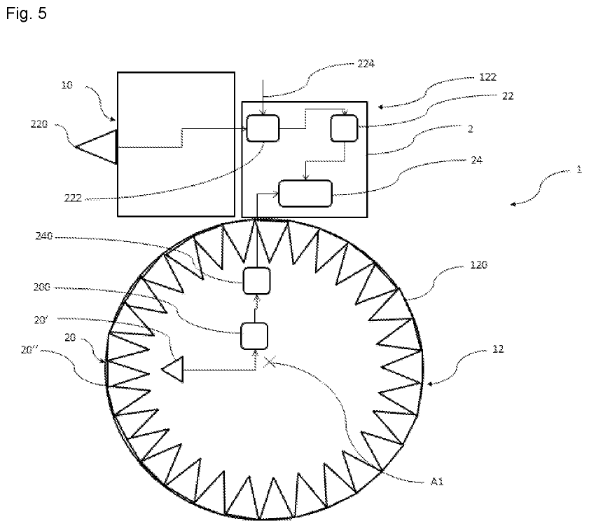

In an ideal variant, a single overspeed sensor, for example the first overspeed sensor 20, may be the only overspeed sensor contained in the overspeed detection device 2 and the first overspeed sensor may comprise thirty mobile elements distributed over the drive wheel 120 as shown in FIG. 5.

Consequently, the signal converter 200, which must process slow signals, is thus capable of transcribing, according to an analogue signal, a predefined number, namely thirty according to the present example, of switches between the complete state and the incomplete state during a complete rotation of the drive wheel. Specifically, the first overspeed sensor 20 changes state between the incomplete state and the complete state every twelve degrees.

Multiplying the number of mobile elements 20″ and therefore the number of switches of the first overspeed sensor 20 between the incomplete state and the complete state thus has the advantage of improving the reaction of the overspeed detection device, as said above. Specifically, as the drive wheel turns at a relatively low speed of rotation and no reduction gear between the electric motor 122 and the drive wheel 120 is installed, the switches between the complete state and the incomplete state of the first overspeed sensor are made, by virtue of using thirty mobile elements, at a frequency of 7.8 Hz at one kilometre per hour, for example, and therefore with a period of 128 milliseconds. However, it is necessary for the overspeed detection device to have a rapid reaction time, that is to say of less than 300 milliseconds, which is advantageously the case when the first overspeed sensor 20 comprises thirty mobile elements 20″.

Adding a filter 240 into the first overspeed sensor 20 at the output of the signal converter 200 may also be envisaged. The filter 240 is arranged between the signal converter 200 and the speed comparator 24. The filter at the output of the signal converter 200 must be sized so as to be able to produce a voltage which is smooth enough for the speed comparator 24 to be able to perform a comparison while at the same time having as little impact as possible on the time related to supplying the measurement of the speed of the drive wheel 120 and to comparing the measurement of the speed of rotation of the drive wheel 120 with the maximum permitted speed of rotation of the drive wheel 120.

According to a preferable configuration, the filter 240 is a third-order filter.

By way of indicative example, the filter 240 may be a filter composed of a 1st-order RC low-pass filter, composed of a resistor and of a capacitor, which is cascaded with a Sallen-Key active filter. In a variant, the Sallen-Key filter may be replaced by two 1st-order RC low-pass filters or by an LC 2nd-order passive filter, composed of a coil and of a capacitor, for example.

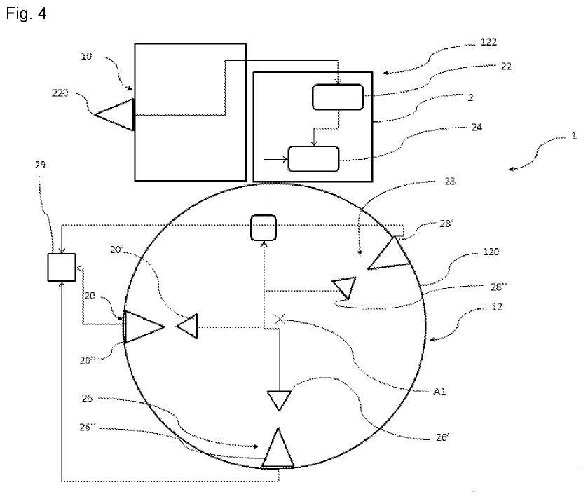

The overspeed detection device 2 may also comprise a generalized malfunction detector 29 for the first overspeed sensor 20, for the second overspeed sensor 26 and for the third overspeed sensor 28, as shown in FIG. 4, which is intended to detect a simultaneous malfunction of the first overspeed sensor 20 and of the second overspeed sensor 26, or of the second overspeed sensor 26 and of the third overspeed sensor 28, or of the first overspeed sensor 20 and of the third overspeed sensor 28, or indeed of the first overspeed sensor 20, of the second overspeed sensor 26 and of the third overspeed sensor 28.

Thus, when the generalized malfunction detector 29 detects that two overspeed sensors are not operating correctly, then the generalized malfunction detector informs the user of impaired operation of the overspeed detection device 2. Also, when the generalized malfunction detector 29 detects that the three overspeed sensors 20, 26 and 28 are not operating correctly, then the generalized malfunction detector informs the user of a malfunction of the overspeed detection device 2.

Furthermore, the first overspeed sensor 20, the second overspeed sensor 26 and/or the third overspeed sensor 28 may be Hall effect sensors. These sensors have a simple architecture and may be very easily incorporated into the motor/wheel assembly 12.

By way of indicative example, as each overspeed sensor delivers a binary signal, it is possible for the generalized malfunction detector 29 to detect the state of each overspeed sensor out of the first overspeed sensor 20, the second overspeed sensor 26 and the third overspeed sensor 28 simultaneously. Also, when the first overspeed sensor 20, the second overspeed sensor 26 and the third overspeed sensor 28 display the same state simultaneously, then the generalized malfunction detector informs the user of a malfunction of the overspeed detection device 2. The generalized malfunction detector 29 thus makes it possible to warn of a common-cause failure which leads to the loss of the entire function of monitoring the overspeed of the vehicle 1. More specifically, according to a configuration with three Hall effect overspeed sensors 20, 26 and 28, the signals from each of the first, second and third Hall effect overspeed sensors are phase-shifted in order to know the angular position of the electric motor 122 approximately. Each Hall effect overspeed sensor out of the first, the second and the third overspeed sensors may produce a binary signal, which yields eight possible combinations. However, only six combinations of signals are possible for a desired arrangement of the first, second and third Hall effect overspeed sensors. Consequently, the generalized malfunction detector 29 makes it possible to determine whether one of the two “impossible” combinations is obtained and reflects the fault of one overspeed sensor out of the first overspeed sensor 20, the second overspeed sensor 26 and the third overspeed sensor 28.

In a variant, the first overspeed sensor 20, the second overspeed sensor 26 and/or the third overspeed sensor 28 may be rotary sensors or optical sensors.

Advantageously, the invention works for an electric motor 10 commonly called an in-wheel motor in the literature, that is to say a motor directly connected to a drive wheel which is itself driven by the electric motor 122. Nevertheless, a person skilled in the art may easily envisage adding an intermediate member for, for example, modifying the force and/or the torque generated by the electric motor, such as a reduction gear, for example. A vehicle 1 comprising this type of motor/wheel assembly 12 and overspeed detection device 2 may be an autonomous vehicle such as, for example, a robot or an autonomous delivery robot, or indeed a remotely controlled vehicle such as a controlled delivery robot.

The invention thus has the advantage of making it possible to detect an overspeed on the part of the autonomous mobile vehicle during its movement in its area of movement as a function of its close environment by jointly using a sensor positioned directly in the drive wheel and a lidar sensory sensor making it possible to stop the vehicle 1 when the situation seems critical.

1. A vehicle configured to move in an area of movement, the vehicle comprising a chassis and a motor/wheel assembly comprising at least one drive wheel and an electric motor driving the drive wheel in rotation, the vehicle comprising an overspeed detection device for the drive wheel, the overspeed detection device comprising a first overspeed sensor, the first overspeed sensor being configured to measure a speed of rotation of the drive wheel,
the overspeed detection device comprising a speed reference device configured to establish a maximum speed of rotation of the drive wheel, the speed reference device comprising an optical sensor configured to determine a close environment of the drive wheel, the optical sensor being arranged against the chassis, the maximum speed of rotation being at least a function of the close environment, of a predefined functional speed threshold and of a direction of rotation of the drive wheel,
the overspeed detection device comprising a speed comparator for comparing the speed of rotation of the drive wheel with the maximum speed of rotation of the drive wheel, the speed comparator being configured to stop the rotation of the drive wheel if the speed of rotation of the drive wheel is greater than the maximum speed of rotation of the drive wheel,
the first overspeed sensor comprising a signal converter configured to convert a switching frequency of the first overspeed sensor into an analogue voltage.

2. The vehicle according to claim 1, wherein the first overspeed sensor comprises a fixed element positioned in the drive wheel and at least one mobile element positioned at a radial extremity of the mobile wheel with respect to the axis of rotation.

3. The vehicle according to claim 1, wherein the first overspeed sensor comprises a filter arranged between the signal converter and the speed comparator.

4. The vehicle according to claim 1, wherein the optical sensor is a lidar sensor.

5. The vehicle according to claim 4, the lidar sensor being configured to generate a first map of the close environment, the lidar sensor comprising a second programming input configured to program an area of attention of the vehicle in the area of movement.

6. The vehicle according to claim 1, wherein the overspeed detection device comprises a second overspeed sensor arranged at a predefined angle with respect to the first overspeed sensor, the second overspeed sensor being configured to measure a speed of rotation of the drive wheel.

7. The vehicle according to claim 6, wherein the first overspeed sensor and the second overspeed sensor are Hall effect sensors or rotary sensors or optical sensors.

8. The vehicle according to claim 1, wherein the overspeed detection device comprises a third overspeed sensor arranged at a predefined angle with respect to the first overspeed sensor and with respect to the second overspeed sensor, the third overspeed sensor being configured to measure a speed of rotation of the drive wheel.

9. The vehicle according to claim 1, wherein the overspeed detection device comprises a generalized malfunction detector for the first overspeed sensor, for the second overspeed sensor and for the third overspeed sensor, the generalized malfunction detector being configured to detect a simultaneous malfunction of the first overspeed sensor and of the second overspeed sensor, or of the second overspeed sensor and of the third overspeed sensor, or of the first overspeed sensor and of the third overspeed sensor, or indeed of the first overspeed sensor, of the second overspeed sensor and of the third overspeed sensor.

10. The vehicle according to claim 1, wherein the electric motor is incorporated into the drive wheel.
